(19) United States
(12) Patent Application Publication
(10) Pub. No.: US 2016/0073110 A1
(43) Pub. Date: Mar. 10, 2016

(54) OBJECT-BASED ADAPTIVE BRIGHTNESS COMPENSATION METHOD AND APPARATUS

(71) Applicant: INTELLECTUAL DISCOVERY CO., LTD., Seoul (KR)

(72) Inventors: Kyung Yong KIM, Suwon-si (KR); Gwang Hoon PARK, Seongnam-si (KR); Dong In BAE, Yongin-si (KR); Yoon Jin LEE, Yongin-si (KR); Young Su HEO, Seoul (KR)

(73) Assignee: INTELLECTUAL DISCOVERY CO., LTD., Seoul (KR)

(21) Appl. No.: 14/784,469

(22) PCT Filed: Apr. 15, 2014
(86) PCT No.: PCT/KR2014/003253

§ 371 Date: Oct. 14, 2015

(30) Foreign Application Priority Data
Apr. 15, 2013 (KR) 10-2013-0040913

(51) Int. Cl. H04N 19/117; H04N 19/597; H04N 19/44; H04N 19/176; H04N 19/182

(52) U.S. Cl. CPC H04N 19/117; H04N 19/176; H04N 19/182; H04N 19/44; H04N 19/597

(57) ABSTRACT

A brightness compensation method, according to one embodiment of the present invention, comprises the steps of: receiving a bitstream including encoded images; performing prediction encoding for the bitstream according to an intra mode or an inter mode; and compensating brightness of the current picture to be encoded according to the previous encoded prediction picture, wherein the step for compensating brightness includes a step for adaptively compensating the current picture to be encoded according to pixel units on the basis of the depth information included in the bitstream.

### BACKGROUND OF THE INVENTION

1. Field of the Invention

The present invention relates a method for efficiently encoding and decoding an image by using depth information.

2. Discussion of the Related Art

A 3D video vividly provides a 3D effect as if a user looks and feels in the real world to the user through a 3D display device. As a research related therewith, a 3D video standard is in progress by JCT-3V (The Joint Collaborative Team on 3D Video Coding Extension Development) which is a joint standardization group of MPEG (Moving Picture Experts Group) of ISO/IEC and VCEG (Video Coding Experts Group) of ITU-T. The 3D video standard includes a standard regarding an advanced data format that can support reproduction of a stereoscopic image and an autostereoscopic image by using an actual image and technology related therewith.

### SUMMARY OF THE INVENTION

An object of the present invention is to provide a method that can efficiently perform brightness compensation applied to image encoding/decoding by using depth information.

In accordance with an embodiment of the present invention, a brightness compensating, includes: receiving a bitstream including an encoded image; performing of prediction decoding for the bitstream according to an intra mode or an inter mode; and compensating brightness of a current picture to be decoded according to previously decoded prediction picture brightness, wherein the compensating of the brightness includes adaptively compensating the brightness for each object based on depth information included in the bitstream.

According to the present invention, a compensation value for each object is derived by using a depth information map as a sample in performing brightness compensation to improve encoding efficiency of an image.

### BRIEF DESCRIPTION OF THE DRAWINGS

FIG. 1 is a diagram illustrating one example for a basic structure and a data format of a 3D video system;

FIG. 2 is a diagram illustrating one example of an actual image and a depth information map image;

FIG. 3 is a block diagram illustrating one example of a configuration of an image encoding apparatus;

FIG. 4 is a block diagram illustrating one example of a configuration of an image decoding apparatus;

FIG. 5 is a block diagram for describing one example of a brightness compensating method;

FIG. 6 is a diagram for describing the relationship between texture luminance and a depth information map;

FIG. 7 is a diagram illustrating one example of a method for configuring a sample in order to compensate brightness in interview estimation;

FIG. 8 is a diagram for describing a method of object based adaptive brightness compensation according to an embodiment of the present invention;

FIG. 9 is a diagram illustrating an embodiment of a method for configuring a sample in order to compensate brightness by using a depth information value;

FIG. 10 is a diagram for describing a method of brightness compensation according to a first embodiment of the present invention;

FIG. 10A is a flowchart illustrating the method of brightness compensation according to the first embodiment of the present invention;

FIG. 11 is a diagram for describing a method of brightness compensation according to a second embodiment of the present invention;

FIG. 11A is a diagram illustrating a communication method according to a second embodiment of the present invention.

FIG. 12 is a diagram illustrating an embodiment of a method for configuring samples of a current picture and a prediction picture of a texture at the time of performing object based brightness compensation;

FIG. 13 is a diagram illustrating examples of a depth information map; and

FIG. 14 is a diagram illustrating embodiments of a method for configuring a depth value interval.

### DETAILED DESCRIPTION OF THE EMBODIMENTS

Contents given below just exemplify a principle of the invention. Therefore, those skilled in the art may invent various devices that implement the principle of the present invention and are included in the concept and the scope of the present invention even though not clearly described or illustrated in the present specification. Further, it should be appreciated that all conditional terms and embodiments enumerated in the present specification are apparently intended only for the purpose of appreciating the concept of the present invention in principle and are not limited to particularly enumerated embodiments and states as described above.

It shall be understood that all detailed descriptions enumerating a specific exemplary embodiment, as well as the principle, the aspect, and the exemplary embodiments of the present invention are intended to include a structural and functional equivalent thereof. Further, it shall be understood that the equivalents include an equivalent to be developed in the future, that is, every element invented so as to perform the same function regardless of a structure, as well as a currently publicly-known equivalent.

Therefore, for example, the block diagram of this specification is understood to represent a conceptual aspect of an illustrative circuit which specifies the principle of the invention. Similarly, all of the flowcharts should be understood to be substantially expressed in computer-readable media and to express a variety of processes performed by a computer or a processor, regardless of whether the computer or the processor is clearly illustrated.

Functions of various devices illustrated in the drawings including functional blocks that are expressed as a processor or a concept similar thereto may be provided for use of dedicated hardware and use of hardware having capability to execute software in association with appropriate software. When the functions are provided by the processor, the functions may be provided by a single dedicated processor, a single shared processor, or a plurality of individual processors, and a portion thereof may be shared.

Further, clear use of the processor, control, or terminology proposed as a similar concept thereto should not be interpreted by exclusively citing hardware having the capability to execute software, and should be understood to allusively include digital signal processor (DSP) hardware, and ROM, RAM, and a non-volatile memory for storing software without restriction. Publicly known and commonly used Other hardware may be included.

In claims of this specification, components represented as means to perform the function described in the detailed description, for example, are intended to include a combination of circuit elements which perform the above-mentioned functions or all methods which perform functions including all types of software including a firmware/microcode and combined with an appropriate circuit which executes the software in order to perform the function. In the invention defined by the claims, the functions provided by the various described means are combined with each other and also combined with the method demanded by the claims so that any means which provides the above-mentioned function is understood to be equivalent as understood from the specification.

The aforementioned objects, characteristics, and advantages will be more apparent through the detailed description below related to the accompanying drawings, and thus those skilled in the art to which the present invention pertains will easily implement the technical spirit of the present invention. In describing the present invention, a detailed explanation of known related functions and constitutions may be omitted so as to avoid unnecessarily obscuring the subject matter of the present invention.

Hereinafter, exemplary embodiments according to the present invention will be described with reference to the accompanying drawings in detail.

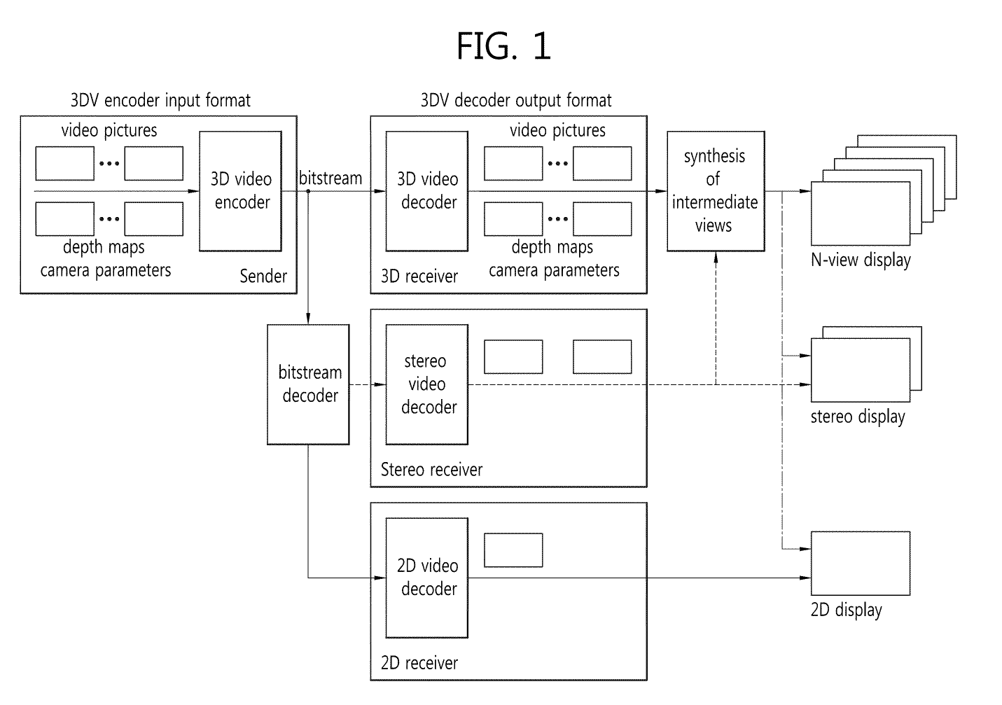

FIG. 1 is a diagram illustrating one example for a basic structure and a data format of a 3D video system.

A basic 3D video system considered in a 3D video standard is illustrated in FIG. 1 and as illustrated in FIG. 1, a depth information image being used in the 3D video standard is encoded together with a general image to be transmitted to a terminal as a bitstream. At a transmitting side, image contents at N (N≧2) viewpoints are acquired by using a stereo camera, a depth information camera, a multi-view camera, transform of a 2D image into a 3D image, and the like. The acquired image contents may include N-viewpoint video information and depth information map information, and camera related additional information. The N-viewpoint image contents are compressed by using a multi-view video encoding method and the compressed bitstream is transmitted to the terminal through a network. At a receiving side, the received bitstream is decoded by using a multi-view video encoding method to restore an N-viewpoint image. The restored N-viewpoint image generates virtual-viewpoint images at N viewpoints or more by a depth-image-based rendering (DIBR) process. The generated virtual-viewpoint images at the N viewpoints or more are reproduced to suit various stereoscopic display devices to provide an image having a 3D effect to a user.

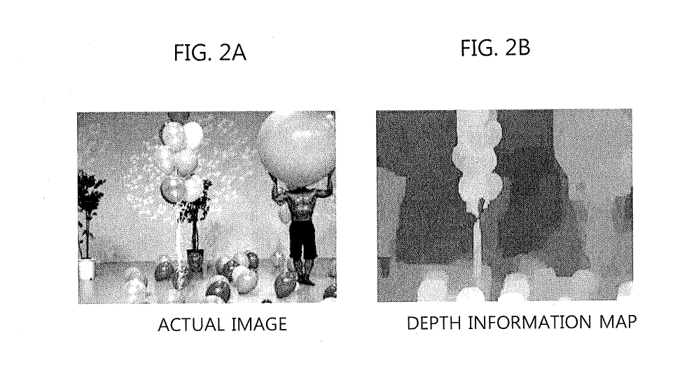

A depth information map used to generate the virtual-viewpoint image expresses a distance (depth information corresponding to each pixel with the same resolution as a real image) between a camera and an actual object in the real world as a predetermined bit number. As an example of the depth information map, FIG. 2 illustrates a “balloons” image (FIG. 2A) used in a 3D video encoding standard of MPEG which is an international standardization organization and a depth information map thereof (FIG. 2B). Actually, the depth information map of FIG. 2 expresses depth information shown in a screen as 8 bits per pixel.

As an example of encoding the actual image and the depth information map thereof, encoding may be performed by using high efficiency video coding (HEVC) which is jointly standardized in MPEG (Moving Picture Experts Group) and VCEG (Video Coding Experts Group) having highest encoding efficiency among video encoding standards developed up to now.

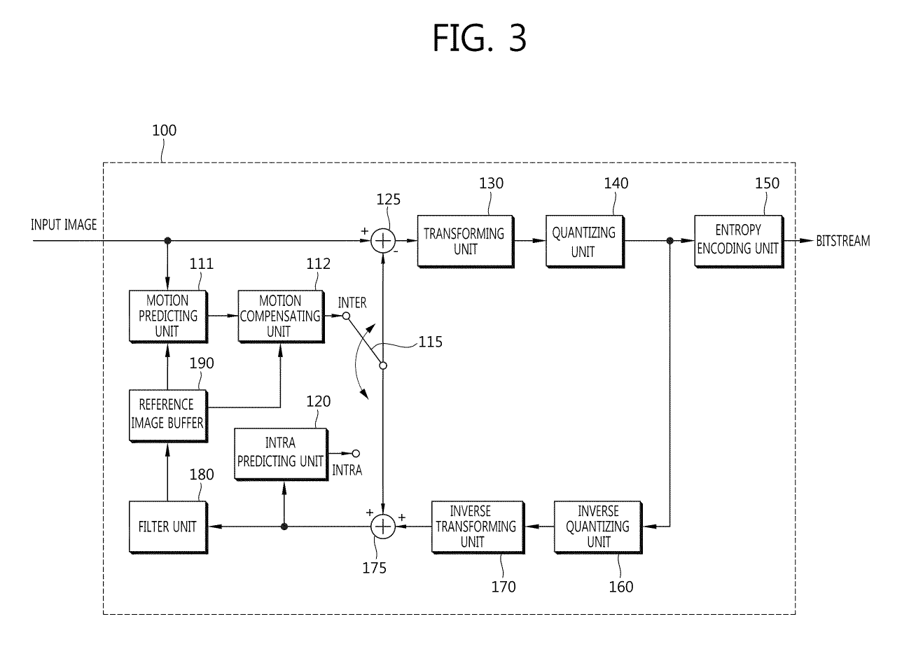

FIG. 3 which illustrates one example of an image encoding apparatus as a block diagram illustrates an encoding structural diagram of H.264.

Referring to FIG. 3, a unit of processing data in the H.264 encoding structural diagram is a macroblock having a pixel size of 16×16 long and wide and an image is received and encoded in an intra mode or an inter mode to output the bitstream.

In the case of the intra mode, a switch is switched into intra and in the case of the inter mode, the switch is switched into inter. In a primary flow of the encoding process, a prediction block for a block image which is first input is generated and thereafter, a difference between the input block and the prediction block is acquired to encode the difference.

First, the prediction block is performed according to the intra mode and the inter mode. First, in the case of the intra mode, the prediction block is generated by spatial prediction by using an already encoded peripheral pixel value of a current block during an intra prediction process and in the inter mode, a motion vector is acquired by finding an area in a reference image stored in a reference image buffer, which best matches the current input block during a motion prediction process and thereafter, motion compensation is performed by using the acquired motion vector to generate the prediction block.

As described above, a residual block is generated by acquiring the difference between the current input block and the prediction bloc and thereafter, encoded. A method for encoding a block is generally divided into the intra mode and the inter mode. According to the size of the prediction block, the intra mode is divided into 16×16, 8×8, and 4×4 intra modes, the inter mode is divided into 16×16, 16×8, 8×16, and 8×8 inter modes, and the 8×8 inter mode is divided into 8×8, 8×4, 4×8, and 4×4 sub inter modes again.

In encoding the residual block, transform, quantization, and entropy encoding are performed in sequence. First, the block encoded in the 16×16 intra mode outputs a transform coefficient by performing transform with respect to a difference block and outputs a hadamard transformed DC coefficient by collecting only DC coefficients among the output transform coefficients and performing hadamard-transform of the collected DC coefficients again.

In the transform process in a block encoded in other encoding modes other than the 16×16 intra mode, the input residual block is input and transformed to output the transform coefficient.

In addition, a quantized coefficient acquired by quantizing the input transform coefficient according to a quantization parameter is output during the quantization process. In addition, during the entropy encoding process, the input quantized coefficient is subjected to entropy encoding according to a probability distribution to be output as the bitstream. Since H.264 performs inter-frame prediction encoding, the current encoded image needs to be decoded and stored so as to be used as a reference image of a subsequent input image.

Therefore, the quantized coefficient is inversely quantized and inversely transformed to generate a block reconfigured through a prediction image and an adder and thereafter, a blocking artifact which occurs during the encoding is removed through a deblocking filter and then, the corresponding coefficient is stored in the reference image buffer.

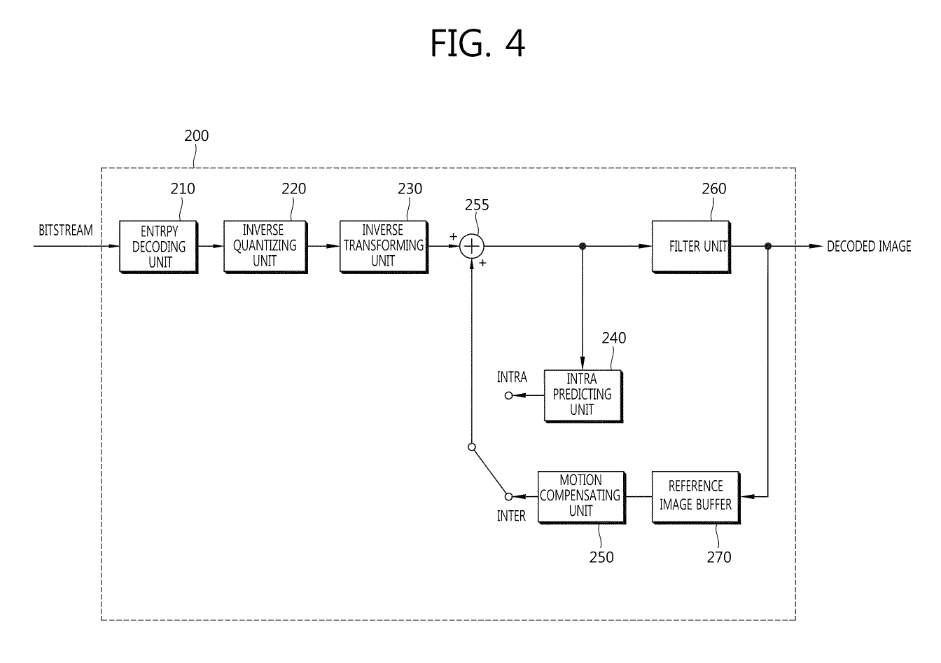

FIG. 4 which illustrates one example of an image decoding apparatus as the block diagram illustrates a decoding structural diagram of H.264.

Referring to FIG. 4, a unit of processing data in the H.264 decoding structural diagram is the macroblock having the pixel size of 16×16 long and wide and the bitstream is received and decoded in the intra mode or the inter mode to output a reconfigured image.

In the case of the intra mode, the switch is switched into intra and in the case of the inter mode, the switch is switched into inter. In a primary flow of the decoding process, first, the prediction block is generated and thereafter, a result block acquired by decoding the received bitstream and the prediction block are added to each other to generate a reconfigured block.

First, the prediction block is generated according to the intra mode and the inter mode. First, in the case of the intra mode, the prediction block is generated by the spatial prediction by using the already encoded peripheral pixel value of the current block during the intra prediction process.

In the case of the inter mode, the motion compensation is performed by finding an area in the reference image stored in the reference image buffer by using the motion vector to generate the prediction block.

During the entry decoding process, the received bitstream is subjected to the entropy-decoding according to the probability distribution to output the quantized coefficient. The quantized coefficient is inversely quantized and inversely transformed to generate the block reconfigured through the prediction image and the adder and thereafter, the blocking artifact is removed through the deblocking filter and then, the corresponding coefficient is stored in the reference image buffer.

As an example of another method for encoding the actual image and the depth information map thereof, the high efficiency video coding (HEVC) may be used, which is jointly standardized in the MPEG (Moving Picture Experts Group) and the VCEG (Video Coding Experts Group) having highest encoding efficiency among video encoding standards developed up to now. This may provide a high-resolution image with a lower frequency bandwidth than a current frequency bandwidth.

The HEVC includes new various algorithms such as an encoding unit and an encoding structure, inter-screen prediction, intra-screen prediction, interpolation, filtering, a transform method, and the like.

When prediction encoding is used in 3D video encoding, luminance of a current picture to be encoded and luminance of a previously encoded prediction picture are totally or partially different from each other. The reason is that a location and a state of a camera or an illumination are changed momentarily. A brightness compensating method has been proposed in order to complement the problem.

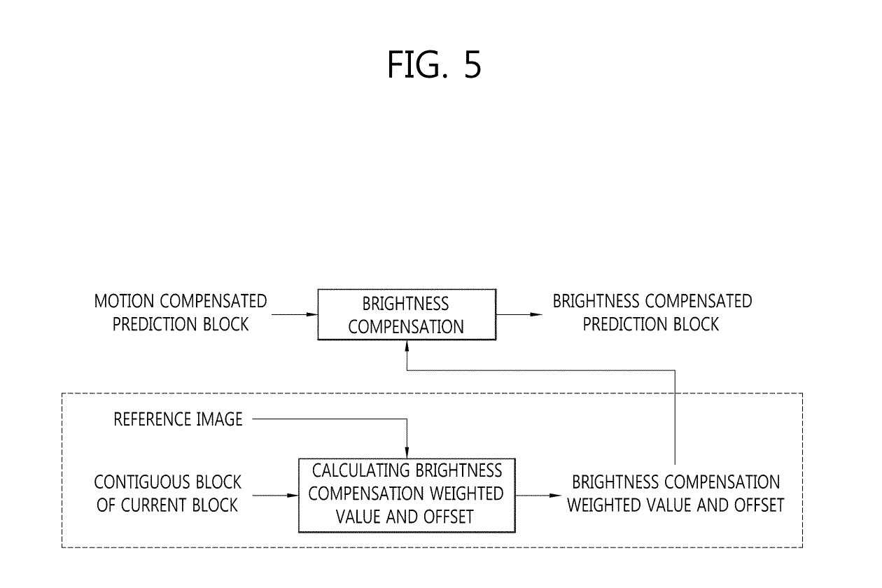

FIG. 5 is a block diagram for describing one example of a brightness compensating method.

Referring to FIG. 5, brightness compensating methods are methods that uses pixels around the current block and pixels around the prediction block in the reference image as samples to obtain brightness differences among the samples and calculate a brightness compensation weighted value and an offset value through the obtained differences.

In the existing brightness compensating methods, the compensation is performed every block and further, the same brightness weighted value and offset value are applied to both all pixels values in one block.

Pred[x,y]=α·Rec[x,y]+β [Equation 1]

In Equation (1) given above, Pred[x,y] represents a brightness compensated prediction block and Rec[x,y] represents the prediction block of the reference image. Further, in the equation, α and β values represent the weighted value and the offset value, respectively.

Pixels in a block in which the brightness is to be compensated are not flat and there are many cases in which the pixels are constituted by multiple different areas such as a background and an object. Since a luminance variation degree varies for each object according to the position of the object, a method that uses the same compensation value with respect to all pixels in the block like the existing method is not optimal.

Therefore, a method that distinguishes the objects in the block and uses compensation values for the respective objects is required.

According to an embodiment of the present invention, when the depth information map used as additional information is used in the 3D video encoding, the objects may be distinguished, and as a result, object based brightness compensation may be effectively used through the proposed method.

The existing method performs the brightness compensation for each block, but the present invention proposes object based adaptive brightness compensation using the depth information map.

When the brightness compensation is performed with respect to texture luminance in the 3D video encoding, the luminance variation degree by movement of the camera may vary according to the position of the object. Therefore, when the brightness compensation is performed based on the object, higher efficiency may be achieved.

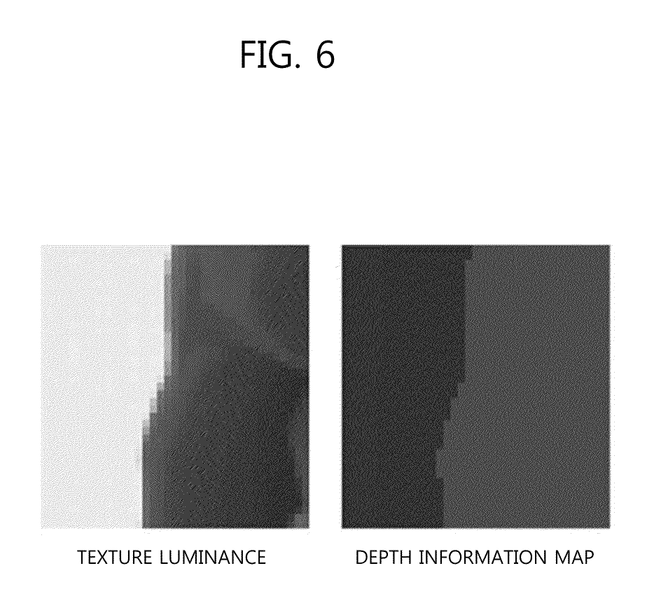

FIG. 6 is a diagram for describing the relationship between texture luminance and a depth information map.

As illustrated in FIG. 6, objects boundary lines of the texture luminance and the depth information map almost coincide with each other and depth values that belong to different objects are clearly distinguished based on a specific threshold point on the depth information map. Therefore, it is possible to perform the object based brightness compensation based on the depth information map.

Meanwhile, when the weighted value and the offset value for the brightness compensation are included in the bitstream, a bit quantity increases. In order to solve the problem in increase of the bit quantity, the weighted value and the offset value for the brightness compensation are obtained through a contiguous block of the current block and a contiguous block of a corresponding block in the reference image. That is, the existing adaptive brightness compensating method uses pixels around the current block and the prediction blocks on the texture in order to prevent the compensation value from being explicitly transmitted.

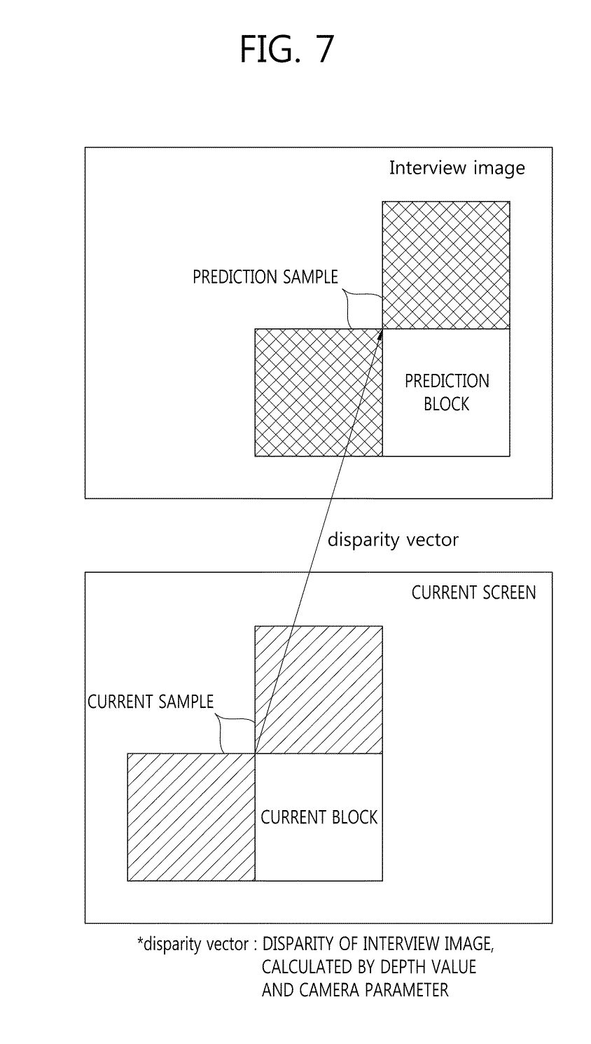

FIG. 7 is a diagram illustrating one example of a method for configuring a sample in order to compensate brightness in interview estimation.

Referring to FIG. 7, since the pixels of the current block may not be found while decoding, the compensation value is derived based on differences among samples by using the contiguous pixel values of the current block and the prediction block as the samples.

Herein, in the case of the samples, a current sample represents the pixels around the current block and a prediction sample represents the pixels around the prediction block.

Current sample=set of pixels around current block

Prediction sample=set of pixels around prediction block in prediction screen (reference image)

Compensation value=f(current sample, prediction sample) f=predetermined function to calculate compensation value by using both samples

An object based adaptive brightness compensating method according to an embodiment of the present invention is used to derive the compensation value for each object by additionally using the depth information map as the sample.

In the embodiment of the present invention, a core point is an assumption that depth information values of respective objects are the same as each other.

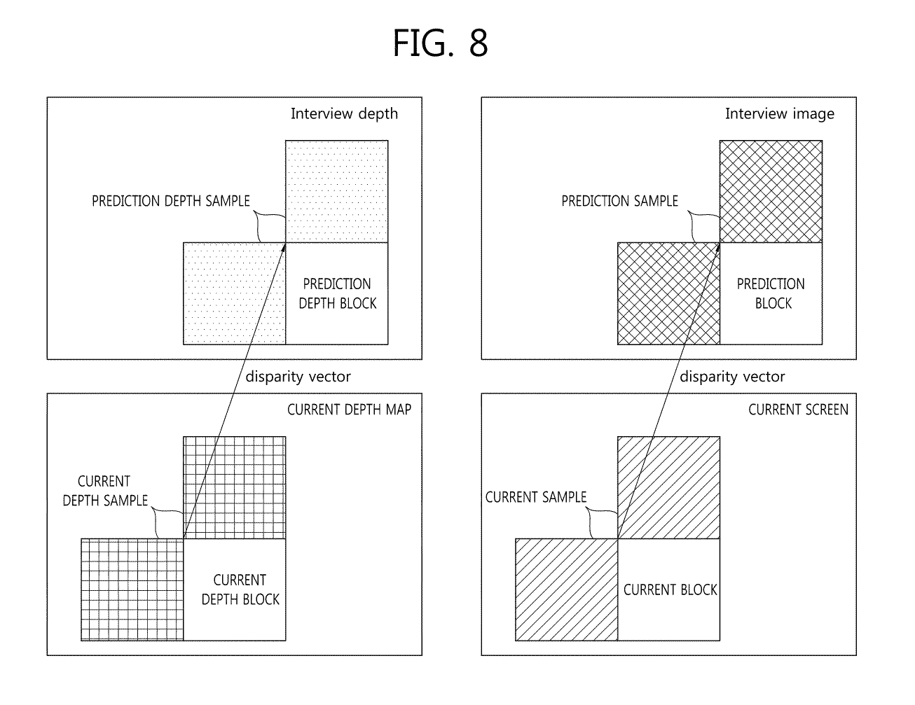

FIG. 8 is a diagram for describing a method of object based adaptive brightness compensation according to an embodiment of the present invention.

Terms used in FIG. 8 are defined as below.

Current sample=set of pixels around current block

Prediction sample=set of pixels around prediction block in prediction screen (reference image)

Current depth sample=set of depth values around current depth block

Prediction depth sample=set of depth values around prediction depth block in prediction depth map (reference depth information image)

Object based compensation value=g(current sample, prediction sample, current depth sample, prediction depth sample) g=predetermined function to calculate compensation value by using texture and depth samples

According to the embodiment of the present invention, when the objects are distinguished, the texture and depth information are used. Herein, a method that derives the brightness compensation value of the texture by using the depth information map as the additional information may be variously applied.

Pixel Based Brightness Compensation using Depth Information

According to the embodiment of the present invention, the method may be used to configure depth information values of contiguous blocks of a depth information map block corresponding to a texture block as samples and thereafter, derive independent compensation values for respective pixels in the current texture block or pixel sets during a predetermined interval.

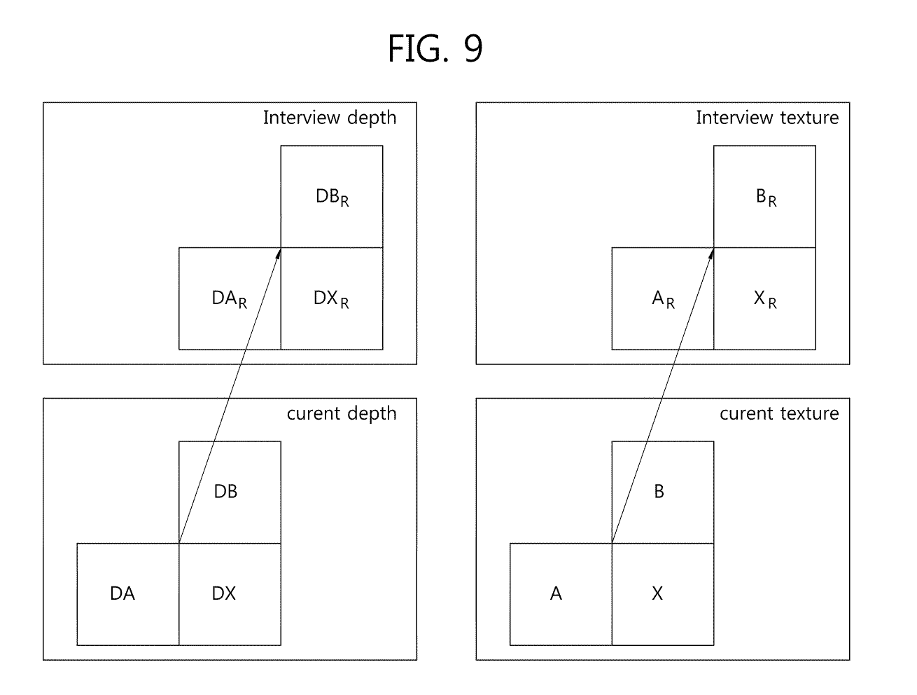

FIG. 9 is a diagram illustrating an embodiment of a method for configuring a sample in order to compensate brightness by using a depth information value.

Referring to FIG. 9, X, A, and B represents a current block, a left block of the current block, and an upper block of the current block, respectively.

Since pixel information may not be found while decoding, pixels positioned around the current block X and pixels positioned around a prediction block XR are used as samples for the texture. As one example, all or some of pixels in A, B, AR, and BR which are contiguous blocks of the X and XR may be used as the samples for the texture.

Further, pixels positioned around a current depth information block DX and a prediction depth information block DXR are used as samples for the depth information. As one example, all or some of pixels in DA, DB, DAR, and DBR which are contiguous blocks of the DX and DXR may be used as the samples for the depth information.

First, in the depth information sample, Ek which is a brightness compensation value of the texture pixel for each depth information value is obtained. Herein, k represents a predetermined or a predetermined range within a whole range of the depth information value. As one example, when the whole range of the depth information value is a closed interval [0,255], k may be a predetermined value such as 0, 1, 2, 3, etc. or a predetermined range such as [0, 15], [16, 31], [32, 47], etc.

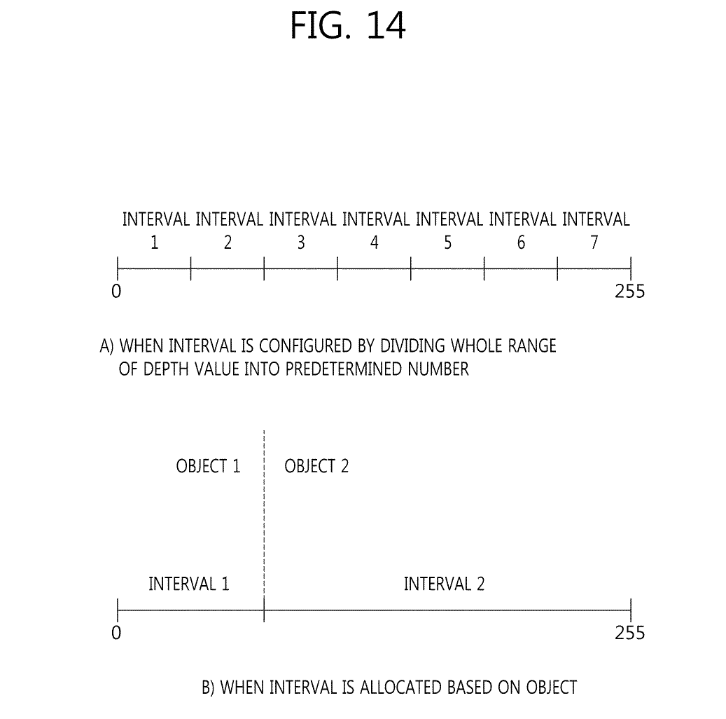

The predetermined range will be described below in detail with reference to FIG. 14.

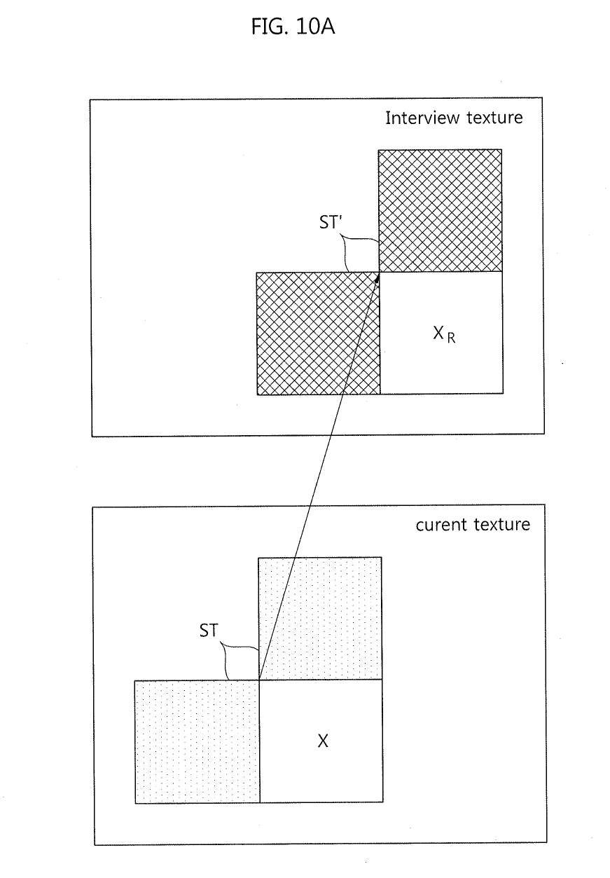

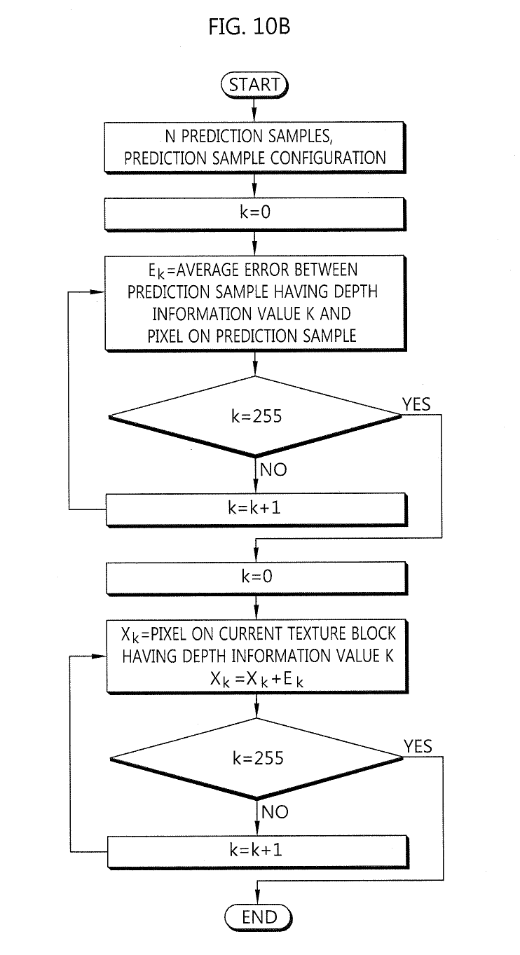

FIG. 10 is a diagram for describing a method of brightness compensation according to a first embodiment of the present invention.

Referring to FIG. 10, a difference of average values of pixels having as k a depth information value corresponding to each pixel within a sample ST for a current picture and a sample ST′ for a prediction picture of a texture illustrated in FIG. 10 may be used in order to obtain Ek as shown in Equation (2) given below.

Eₖ=Avg(STₖ)−Avg(ST′ₖ) [Equation 2]

In this case, STk and ST′k represent sets of pixels having as k depth information values that are present in STk and ST′k, respectively.

Xₖ=Xₖ+Eₖ [Equation 3]

Thereafter, Equation (3) given above is applied to each pixel of the current texture block X having the depth information value as k to perform the brightness compensation.

FIG. 10A is a flowchart illustrating the method of brightness compensation according to the first embodiment of the present invention.

The pixel based brightness compensating method is processed according to the following process sequence.

(1) The number of samples is defined as N and the current sample and the prediction sample are defined as ST[i] and ST[i] (i=0 . . . N−1), respectively. Further, the current depth sample and the prediction depth sample are defined as SD[i] and SD′[i] (i=0 . . . N−1), respectively.

(2) The current block is defined as T[x, y]. Further, the current depth information block is defined as D[x′, y′]. x=0 . . . X, y=0 . . . Y, x′=0 . . . X′, y′=0 . . . Y′.

In this case, X, Y, X′, and Y′ which are values used to decide the size of the block may be predetermined values.

(3) With respect to the current sample and the prediction block, arrays having as 0 an initial value storing an average value of the pixels having as k the depth information value are defined as STk and ST′k (k=0 . . . K), respectively. Further, with respect to the current sample and the prediction block, arrays having as 0 an initial value storing the number of the pixels having as k the depth information value are defined as Nk and N′k (k=0 . . . K), respectively.

In this case, K to decide a range of the depth information value may be a predetermined value.

(4) An array storing a difference between average values of the current sample and the prediction sample is defined as Ek.

(5) Processes (6) and (7) are repeatedly performed with respect to s=0 . . . N−1.

(6) k=DT[s], Nk=Nk+1, STk=STk+k

(7) k=DT′[s], N′k=N′k+1, ST′k=ST′k+k

(8) Process (9) is repeatedly performed with respect to k=0 . . . K.

(9) STk=STk/Nk, ST′k=ST′k/N′k, Ek=STk−ST′k

(10) Process (11) is repeatedly performed with respect to x=0 . . . X, y=0 . . . Y.

(11) k=D[x, y], T[x, y]=T[x, y]+Ek

Object based brightness compensation using depth information

According to yet another embodiment of the present invention, the method may be used to configure depth information values of contiguous blocks of a depth information map block corresponding to a texture block as samples and thereafter, derive an object based brightness compensation value in the current texture block.

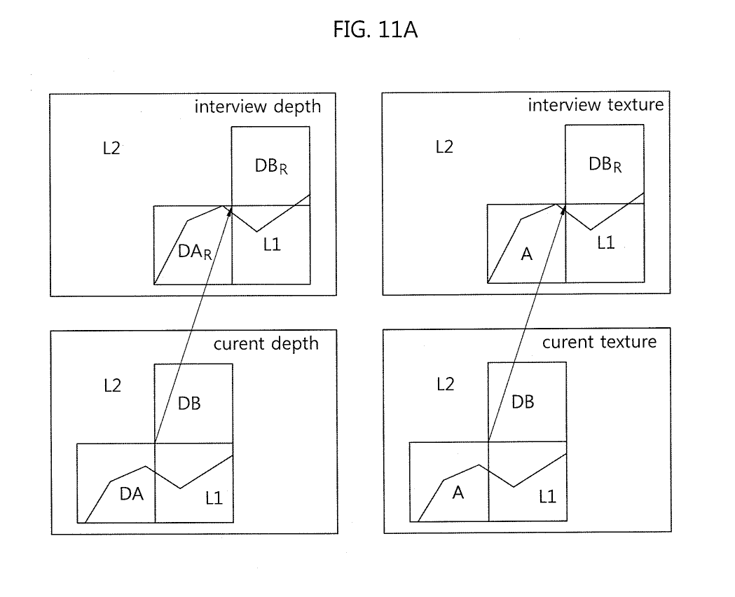

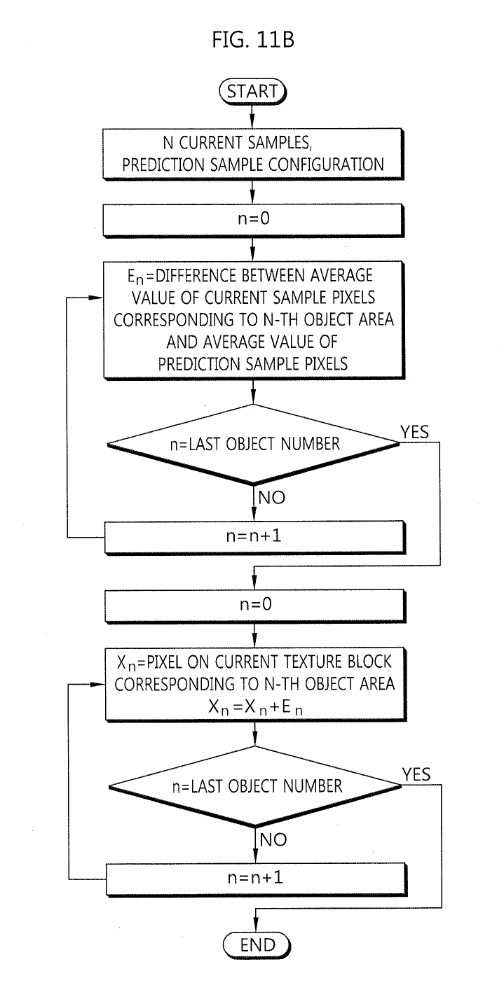

FIG. 11 which illustrates to describe a brightness compensating method according to a second embodiment of the present invention illustrates a method that performs object based brightness compensation based on depth information. FIG. 11A is a flowchart illustrating the brightness compensating method according to the second embodiment of the present invention.

Referring to FIG. 11, an example in which two objects are present on the depth information map is illustrated and L1 represents an object area and L2 represents a background area.

In the depth information map sample, a difference of an average value of texture sample pixels corresponding to the L1 area and an average value of the texture sample pixels corresponding to the L2 area may be used as a brightness compensation value.

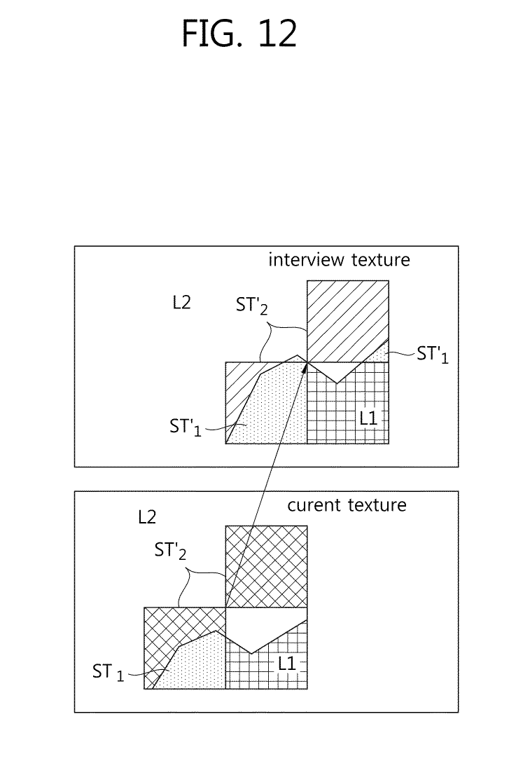

FIG. 12 is a diagram illustrating an embodiment of a method for configuring samples of a current picture and a prediction picture of a texture at the time of performing object based brightness compensation;

Referring to FIG. 12, as shown in Equation (4) given below, En may represent a difference between average values of pixels in a sample STn for an n-th object in the current picture of the texture and a sample ST′n for an n-th object in the prediction picture.

Eₙ=Avg(STₙ)−Avg(ST′ₙ) [Equation 4]

Xₙ=Xₙ+Eₙ [Equation 5]

When the brightness compensation is performed, En which is a compensation value corresponding to the n-th object is added to pixels in the n-th object area with respect to the current texture block X as shown in Equation (5) given above.

Referring back to FIG. 11A, the object based brightness compensating method may be processed according to the following process sequence.

(1) The number of samples is defined as N and the current sample and the prediction sample are defined as ST[i] and ST[i] (i=0 . . . N−1), respectively. Further, the current depth sample and the prediction depth sample are defined as SD[i] and SD′[i] (i=0 . . . N−1), respectively.

(2) The current block is defined as T[x, y]. Further, the current depth information block is defined as D[x′, y′]. x=0 . . . X, y=0 . . . Y, x′=0 . . . X′, y′=0 . . . Y′.

In this case, X, Y, X′, and Y′ which are values used to decide the size of the block may be predetermined values.

(3) With respect to the current sample and the prediction block, arrays having as 0 an initial value storing an average value of the internal pixels of the object k are defined as STk and ST′k (k=0 . . . K), respectively. Further, with respect to the current sample and the prediction block, arrays having as 0 an initial value storing the number of the internal pixels of the object K are defined as Nk and N′k (k=0 . . . K), respectively.

In this case, K to decide the number of objects may be a predetermined value.

(4) An array storing a difference between average values of the current sample and the prediction sample is defined as Ek, with respect to each object.

(5) Processes (6) and (7) are repeatedly performed with respect to s=0 . . . N−1.

(6) Object number to which k=DT[s] belongs, Nk=Nk+1, STk=STk+k

(7) Object number to which k=DT′[s] belongs, N′k=N′k+1, ST′k=ST′k+k

(8) Process (9) is repeatedly performed with respect to k=0 . . . K.

(9) STk=STk/Nk, ST′k=ST′k/N′k, Ek=STk−ST′k

(10) Process (11) is repeatedly performed with respect to x=0 . . . X, y=0 . . . Y.

(11) k=D[x, y], T[x, y]=T[x, y]+Ek is performed.

In the brightness compensating method according to the embodiment described above, encoding efficiency of object based brightness compensation is decided according to how well the objects are distinguished.

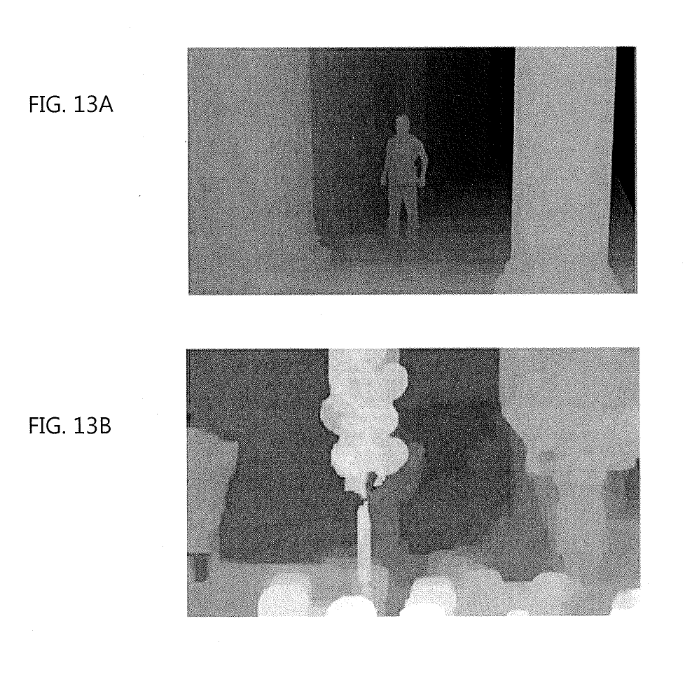

FIG. 13 is a diagram illustrating examples of a depth information map.

When the depth information map is very well generated as illustrated in FIG. 13A, the objects are easily distinguished, and as a result, there is no problem, but in the depth information map, it may be difficult to distinguish the objects from each other as illustrated in FIG. 13B.

Meanwhile, each pixel of the texture has a depth value corresponding thereto.

As a result, according to yet another embodiment of the present invention, a depth value interval corresponding to a predetermined object is configured to regard pixels having a depth value in the corresponding interval as the same object.

FIG. 14 is a diagram illustrating embodiments of a method for configuring a depth value interval.

There are various methods that designate the depth value interval corresponding to each object. For example, predetermined widths may be just configured as intervals as illustrated in FIG. 14A and depth values that belong to the respective objects may be configured as the intervals as illustrated in FIG. 14B. As more depth value intervals are configured, multiple difference compensation values may be used, but complexity increases.

Various methods given below may be used during distinguishing the objects in the block, but the present invention is not limited thereto.

(1) Since the depth information map is distance between the object and the camera, the objects may be easily distinguished and an object location in the depth information map is the same as that of the current image. Therefore, the objects of the current texture image may be distinguished by using the already encoded/decoded depth information map.

(2) In the method (1), as a method for removing dependency between the texture and the depth information, a method that completes the motion compensation for the block during decoding and thereafter, distinguishes the objects by using the motion-compensated texture block may be used.

(3) In the method (1), as the method for removing dependency between the texture and the depth information, a method that completes restoration of the current block during decoding and thereafter, distinguishes the objects by using the objects by using the restored texture block may be used.

Application ranges of all of the aforementioned methods may vary according to a block size or a CU depth. Variables (that is, size or depth information) for deciding the application range may be set for an encoder and a decoder to use predetermined values or to use the predetermined values according to a profile or a level, and when the encoder writes a variable value in the bitstream, the decoder may acquire the value from the bitstream and use the value. When the application range varies according to the CU depth, there may be method A which is applied only to a depth which is equal to or more than a given depth, method B which is applied only to a depth which is equal to or less than the given depth, and method C which is applied only to the given depth, as shown in the following table.

Table 1 shows an example of a range deciding scheme that applies the methods of the present invention when the given CU depth is 2. (O: Applied to corresponding depth, X: Not applied to corresponding depth)

TABLE 1

| CU depth representing | | | |
|---|---|---|---|
| application range | Method a | Method b | Method c |
| 0 | X | O | X |
| 1 | X | O | X |
| 2 | O | O | O |
| 3 | O | X | X |
| 4 | O | X | X |

When the methods of the present invention are not applied to all depths, the depths may be represented by a predetermined indicator (flag) and expressed by signaling a value which is more than a maximum value of the CU depth by one as the Cu depth value representing the application range.

Further, the method may be applied differently to a chroma block according to the size of a luminance block and further, differently applied to a luminance signal image and a chroma image.

TABLE 2

| | | Luminance | Chroma | |
|---|---|---|---|---|
| Luminance | Chroma | appli- | appli- | |
| block size | block size | cation | cation | Methods |
| 4(4 × 4, 4 × | 2(2 × 2) | O or X | O or X | A 1, 2, . . . |
| 2, 2 × 4) | 4(4 × 4, 4 × | O or X | O or X | B 1, 2, . . . |
| | 2, 2 × 4) | | | |
| | 8(8 × 8, 8 × | O or X | O or X | C 1, 2, . . . |
| | 4, 4 × 8, | | | |
| | 2 × 8, etc.) | | | |
| | 16(16 × 16, | O or X | O or X | D 1, 2, . . . |
| | 16 × 8, 4 × | | | |
| | 16, 2 × 16, etc.) | | | |
| | 32(32 × 32) | O or X | O or X | E 1, 2, . . . |
| 8(8 × 8, 8 × | 2(2 × 2) | O or X | O or X | F 1, 2, . . . |
| 4, 2 × 8, etc.) | 4(4 × 4, 4 × | O or X | O or X | G 1, 2, . . . |
| | 2, 2 × 4) | | | |
| | 8(8 × 8, 8 × | O or X | O or X | H 1, 2, . . . |
| | 4, 4 × 8, | | | |
| | 2 × 8, etc.) | | | |
| | 16(16 × 16, | O or X | O or X | I 1, 2, . . . |
| | 16 × 8, 4 × | | | |
| | 16, 2 × 16, etc.) | | | |
| | 32(32 × 32) | O or X | O or X | J 1, 2, . . . |
| 16(16 × 16, | 2(2 × 2) | O or X | O or X | K 1, 2, . . . |
| 8 × 16, | 4(4 × 4, 4 × | O or X | O or X | L 1, 2, . . . |
| 4 × 16, etc.) | 2, 2 × 4) | | | |
| | 8(8 × 8, 8 × | O or X | O or X | M 1, 2, . . . |
| | 4, 4 × 8, | | | |
| | 2 × 8, etc.) | | | |
| | 16(16 × 16, | O or X | O or X | A 1, 2, . . . |
| | 16 × 8, 4 × | | | |
| | 16, 2 × 16, etc.) | | | |
| | 32(32 × 32) | O or X | O or X | b 1, 2, . . . |

Table 2 shows one example a combination of the methods.

Among modified methods of Table 2, when method “G1” is described, the method of the specification may be applied to a luminance signal and a chroma signal in the case where the size of the luminance block is 8(8×8, 8×4, 2×8, etc.) and the size of the chroma block is 4(4×4, 4×2, 2×4).

Among the modified methods, when method “L2” is described, the method of the specification may be applied to the luminance signal and not applied to the chroma signal in the case where the size of the luminance block is 16(16×16, 8×16, 4×16, etc.) and the size of the chroma block is 4(4×4, 4×2, 2×4).

As another modified examples, the method of the specification may be applied to only the luminance signal and not applied to the chroma signal. On the contrary, the method of the specification may be applied to only the chroma signal and not applied to the luminance signal.

Although the encoding method and the encoding apparatus have been described as above in regard to the method and the apparatus according to the embodiments of the present invention, but the present invention may be applied to even the decoding method and apparatus. In this case, the method according to the embodiment of the present invention is performed inversely, and as a result, the decoding method according to the embodiment of the present invention may be performed.

The method according to the present invention may be prepared as a program to be executed in a computer and stored in a computer-readable recording medium and an example of the computer-readable recording medium may include a read only memory (ROM), a random access memory (RAM), a compact disk read only memory (CD-ROM), a magnetic tape, a floppy disk, an optical data storage device, and the like, and also include a medium implemented in a form of a carrier wave (for example, transmission through the Internet).

The computer-readable recording media are distributed on computer systems connected through the network, and thus a computer-readable code may be stored and executed by a distribution scheme. Further, functional programs, codes, and code segments for implementing the method may be easily inferred by a programmer in a technical field to which the present invention belongs.

While the exemplary embodiments of the present invention have been illustrated and described above, the present invention is not limited to the aforementioned specific exemplary embodiments, various modifications may be made by a person with ordinary skill in the technical field to which the present invention pertains without departing from the subject matters of the present invention that are claimed in the claims, and these modifications should not be appreciated individually from the technical spirit or prospect of the present invention.

What is claimed is:

1. A brightness compensating method using depth information, comprising:
receiving a bitstream including an encoded image;
performing of prediction decoding for the bitstream according to an intra mode or an inter mode; and
compensating brightness of a current picture to be decoded according to previously decoded prediction picture brightness,
wherein the compensating of the brightness includes adaptively compensating the brightness for each object based on depth information included in the bitstream.

2. The method of claim 1, wherein the compensating includes configuring depth information values corresponding to texture blocks based on the depth information.

3. The method of claim 1, wherein in the compensating, a range of the depth information value is decided according to an object area and a background area.

4. The method of claim 1, wherein in the compensating, a difference of average values of texture sample pixels corresponding to the object area and texture sample pixels corresponding to a background area based on the depth information is used as a brightness compensation value.

5. The method of claim 1, wherein the compensating includes storing as an array differences in average value between a current sample and a prediction sample for respective objects based on the depth information.

6. The method of claim 1, further comprising:
configuring a depth value interval for configuring the depth information values as samples.

7. A brightness compensating apparatus using depth information, comprising:
a receiving unit receiving a bitstream including an encoded image;
a decoding unit performing of prediction decoding for the bitstream according to an intra mode or an inter mode; and
a compensating unit compensating brightness of a current picture to be decoded according to previously decoded prediction picture brightness,
wherein the compensating unit adaptively compensates the brightness for each object based on depth information included in the bitstream.

8. The apparatus of claim 7, wherein the compensating unit configures depth information values corresponding to texture blocks based on the depth information.

9. The apparatus of claim 7, wherein the compensating unit decides a range of the depth information value according to an object area and a background area.

10. The apparatus of claim 7, wherein the compensating unit uses a difference of average values of texture sample pixels corresponding to the object area and texture sample pixels corresponding to a background area based on the depth information as a brightness compensation value.

11. The apparatus of claim 7, wherein the compensating unit stores as an array differences in average value between a current sample and a prediction sample for respective objects based on the depth information.

12. The apparatus of claim 7, wherein the compensating unit configures a depth value interval for configuring the depth information values as samples.
